(19) United States
(12) Patent Application Publication
(10) Pub. No.: US 2019/0213543 A1
(43) Pub. Date: Jul. 11, 2019

(54) HISTORY MANAGEMENT SYSTEM AND HISTORY MANAGEMENT METHOD

(71) Applicant: OPTiM Corporation, Saga-shi (JP)

(72) Inventor: Shunji SUGAYA, Tokyo (JP)

(21) Appl. No.: 15/546,730

(22) PCT Filed: Sep. 9, 2016
(86) PCT No.: PCT/JP2016/076630

§ 371 Date: Jul. 27, 2017

(51) Int. Cl. G06Q 10/08; G06Q 50/02; G06F 16/903; G06F 16/901

(52) U.S. Cl. CPC G06Q 10/0838; G06F 16/901; G06F 16/903; G06Q 50/02

(57) ABSTRACT

In a history management system 1, a server device 10 records in a ledger database 20, with respect to each of a plurality of products, a history each of a plurality of processes through which the plurality of products passes, and searches the ledger database 20 for the history each of the plurality of processes through which the plurality of products passes. The server device 10 generating access destination information unique to a content history each of the plurality of processes through which the plurality of products passes and for which the history each has been acquired by the search. When receiving an access from a purchaser terminal 50, the server device 10 transmits content corresponding to the content history of the plurality of processes specified by the designated access destination information to the purchaser terminal 50.

### TECHNICAL FIELD

The present invention relates to a technique for managing a product history.

### BACKGROUND ART

There is known in the art a tracing system that makes it possible to trace a distribution route of a product such as food or an industrial product. For example, as awareness of food safety increases, many purchasers of food wish to know a distribution route of food. In such a system, identification information such as a two-dimensional code is attached to merchandise, and the purchaser of the merchandise can obtain information on the distribution route of the merchandise based on this identification information. Regarding the traceability system, Patent Document 1 describes a system in which a large-scale database is used, and which is compiled for distribution on a network. In this system, process information showing a history of a process includes process identifying information, which information includes information on each of a preceding and succeeding process. As a result, even if information that specifies a distribution route of the merchandise is managed using a plurality of databases, a high speed search of the distribution route can be performed.

### PRIOR ART DOCUMENT

### Patent Document

Patent Document 1: Japanese Patent Application Publication No. 2005-222259

### SUMMARY OF THE INVENTION

### Technical Problem

A distribution route of a product can be identified, for example, by tracing a history of the product in order of a plurality of processes through which the product passes. In this case, if a product history content for one or more processes is unknown, reliability of information for the distribution route as a whole may be compromised. In addition, if a product history content is tampered with maliciously, misinformation on the distribution route may be provided based on the product history content that has been tampered with maliciously. Patent Document 1 does not disclose a method for ensuring reliability of all information on a distribution route, taking into account a possibility that a product history content has been tampered with maliciously.

In the present invention there is provided reliable product history content with respect to processes through which a product passes.

### Technical Solution

To achieve the stated object, the present invention provides: a history management system including a recording unit that records in a database, relative to a plurality of products, a history each of a plurality of processes through which the plurality of products passes; a search unit that searches the database for the history each of the plurality of processes through which the plurality of products passes; an access destination information generating unit that generates access destination information unique to the history each of the plurality of processes through which the plurality of products passes and for which the history each has been acquired by the search; an access destination information output unit that outputs the generated access destination information; and a content output unit that outputs a content history corresponding to the history each of the plurality of processes specified by the access destination information when receiving an access request designating the access destination information.

In the present invention when a content history is rewritten, the access destination information generating unit may invalidate the access destination information generated based on the content history before rewriting takes place.

In the present invention, the access destination information generating unit may generate access destination information by assigning character strings to a content history acquired by the search and combining the assigned character strings for each of the plurality of processes.

In the present invention, the access destination information generating unit may assign the character strings by converting the acquired content history according to a predetermined rule, and the content output unit may output the content of the acquired history when the character strings acquired by converting the content history according to the predetermined rule are included in the access destination information.

In the present invention, the database may store ledger data, which is provided for each of the plurality of processes, and in which a history of a corresponding process is recorded. When a history is not acquired from the ledger data corresponding to a first process, the search unit may omit searching for the history for the ledger data corresponding to a second process that is subsequent to that of the first process.

In the present invention, the recording unit may record differing types of history depending on a product or a worker performing work on the product.

In the present invention, a collecting device that collects information on a history of the product may be provided, and the recording unit may record the history based on the information collected by the collecting device.

In the present invention, the product may be a farm product, and the history may include information on an agricultural field in which the farm product is produced.

Further, the present invention provides a history management method including recording in a database a history each of a plurality of processes through which a product passes, with respect to each of a plurality of products; searching the database for the history each of the plurality of processes with respect to each of the products; generating access destination information unique to the content of the history each of the plurality of processes with respect to a product for which a history of the plurality of processes has been acquired by the search; outputting the generated access destination information; and outputting content history for each of the plurality of processes specified by the access destination information when receiving an access request designating the access destination information.

### Effects of the Invention

According to the present invention, it is possible to ensure reliability of a history of a plurality of processes through which a product passes and to provide an accurate history for each of a product.

### BRIEF DESCRIPTION OF THE DRAWINGS

FIG. 1 is a diagram showing an overall configuration of a history management system according to an embodiment of the present invention.

FIG. 2 is an explanatory diagram of an example of a history uploaded by an information processing device according to the embodiment.

FIG. 3 is a diagram showing an example of a configuration of ledger data recorded in a ledger database according to the embodiment.

FIG. 4 is a diagram showing an example of a configuration of ledger data recorded in a ledger database according to the embodiment.

FIG. 5 is a block diagram showing a hardware configuration of a server device, an information processing device, and a purchaser terminal according to the embodiment.

FIG. 6 is a block diagram showing a functional configuration of a history management system according to the embodiment.

FIG. 7 is a sequence diagram showing processing for recording a history of a product in ledger data in a history management system according to the embodiment.

FIG. 8 is a sequence diagram showing processing for searching for a history in a history management system according to the embodiment.

FIG. 9 is a flowchart showing access destination information generating processing according to the embodiment.

FIG. 10 is a diagram explaining a history search according to the embodiment.

FIG. 11 is an explanatory diagram of a history search according to the embodiment.

FIG. 12 is an explanatory diagram regarding access destination information according to the embodiment.

FIG. 13 is an explanatory diagram of a history search according to the embodiment.

FIG. 14 is a sequence diagram showing processing for downloading content in a history management system according to the embodiment.

FIG. 15 is a flowchart showing processing of rewriting a history in a history management system according to the embodiment.

FIG. 16 is a diagram showing an example of a configuration of ledger data after a history is rewritten according to the embodiment.

DESCRIPTION OF REFERENCE NUMBERS
1: history management system, 10: server device, 101: recording unit, 102: search unit, 103: access destination information generating unit, 104: access destination information output unit, 105: content output unit, 12, 42, 52: communication unit, 13, 45, 55: storage unit, 14, 46: interface, 43, 53: operation unit, 44, 54: display unit, 56: camera, 20: ledger database, 21: agricultural field ledger data, 22: crop ledger data, 23: sorting ledger data, 24: delivery ledger data, 25: store ledger data, 30: history collecting device, 40, 40A, 40B, 40C, 40D, 40E: information processing device, 50: purchaser terminal, 700: product, 900: merchandise, 910: two-dimensional code.

### DETAILED DESCRIPTION OF THE EMBODIMENTS

A history management system according to the present invention manages, relative to a plurality of products, a history each of a plurality of processes through which a product passes. A distribution route of the product may be identified, for example, by tracing a history of the product in order of the plurality of processes through which the product passes. A product whose history is managed by the present invention may be any kind of product, with examples of products including final products such as foods and manufactured items; intermediate processed products to be used in production; or raw materials to be used in production. The plurality of processes through which the product passes are predetermined. The plurality of processes may include, for example, a plurality of processes from a production stage (by a producer) to a consumption stage by a purchaser, or may include a plurality of processes from a production stage to a disposal stage.

In the embodiments described below, a case where the product is a farm product such as a vegetable is described. The plurality of processes through which the product passes consists of five processes, namely, an agricultural field process, a crop process, a sorting process, a delivery process, and a store process.

In the following description, “a plurality of processes” refers to the foregoing five processes unless otherwise specified.

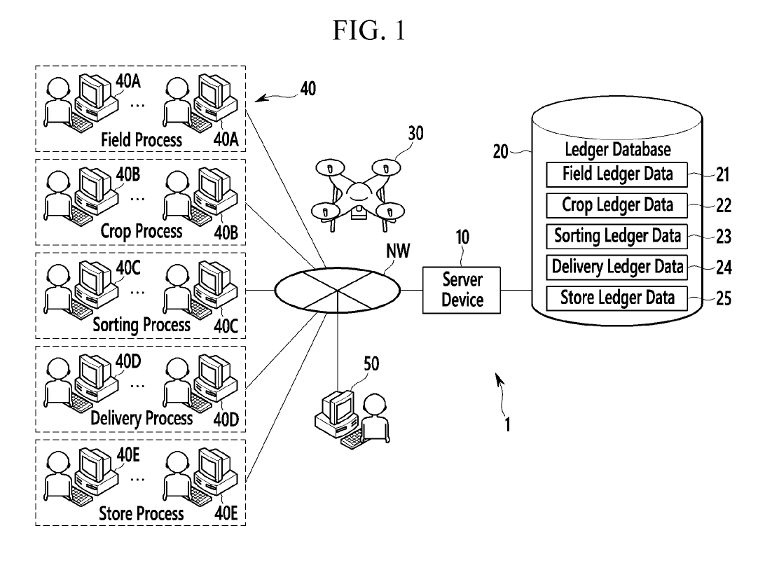

A history of the agricultural field process includes information relating to an agricultural field in which the product is produced. A history of the crop process includes information relating to the product itself. A history of the sorting process includes information on sorting of the product. A history of the delivery process includes information on delivery of the product. A history of the store process includes information on store where the product is sold. A history of the product includes, for example, data such as text (a written description), a still or moving image, or may include other data. FIG. 1 is a diagram showing an overall configuration of a history management system 1 according to an embodiment of the present invention. The history management system 1 includes a server device 10, a ledger database 20, a history collecting device 30, a plurality of information processing devices 40 (40A, 40B, 40C, 40D, and 40E), and a purchaser terminal 50.

The server device 10 manages a history each of a plurality of products by use of the ledger database 20. The server device 10 also records a history of a product uploaded by the information processing device 40 to the ledger database 20. The ledger database 20 stores ledger data to record a history of the product. The ledger data is separated (dispersed) for each of a plurality of processes. Specifically, the ledger database 20 stores agricultural field ledger data 21 corresponding to an agricultural field process, crop ledger data 22 corresponding to a crop process, sorting ledger data 23 corresponding to a sorting process, delivery ledger data 24 corresponding to a delivery process, and store ledger data 25 corresponding to a store process.

While in the present embodiment the ledger database 20 is a device (for example, a server device) that is provided external to the server device 10, the ledger database 20 may be a device (for example, a hard disk device) that is provided inside the server device 10.

The history collecting device 30 collects product history information. The history collecting device 30 has, for example, a camera and a sensor for measuring environmental information such as temperature, humidity, atmospheric pressure, and the like. The camera is used, for example, to capture a still or moving image of a product or an agricultural field. The sensor is used, for example, to measure information on an environment in which the product is produced.

In FIG. 1, the history collecting device 30 is referred to as an agricultural drone. Here, the history collecting device 30 carries out, under remote control, imaging with a camera, and collection of information on an environment. The history collecting device 30 may be a device other than an agricultural drone. For example, the history collecting device 30 may be a portable terminal such as a smartphone or a tablet computer carried by a worker who performs work related to the product, or a wearable terminal such as a glasses-type terminal worn by the worker.

The information processing device 40 records the history of the product in the server device 10 via a network NW. In FIG. 1, the information processing device 40 is a personal computer. However, the information processing device 40 may be, for example, a portable terminal such as a smartphone or a tablet computer.

The plurality of information processing devices 40 are essentially divided into information processing devices 40A to 40E. The information processing devices 40A to 40E are operated by workers who perform tasks relating to different processes. In FIG. 1, the information processing devices 40A to 40E are shown as a plurality of devices, and in such a case a plurality of work operations are carried out within a single process. The number of information processing devices 40A to 40E is not particularly limited.

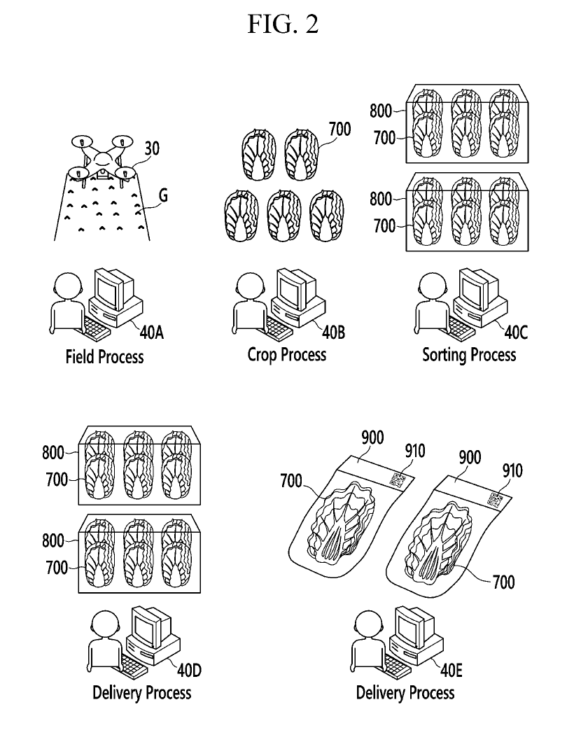

FIG. 2 is an explanatory diagram of a history uploaded by information processing devices 40A to 40E.

An information processing device 40A uploads a history of an agricultural field process. The history of this agricultural field process includes, for example, information on an agricultural field G manually entered by a worker and information on an agricultural field G collected by the history collecting device 30. An information processing device 40B uploads a history of a crop process. The history of the crop process includes, for example, information on a product 700 (in this case, spinach) produced in the agricultural field G, and manually entered by the worker. An information processing device 40C uploads a history of a sorting process. The history of the sorting process includes, for example, information on sorting of the product 700. Sorting includes sorting the plurality of products 700 according to predetermined rules (size, quality, etc.) and packing the sorted products 700 into corrugated containers 800. An information processing device 40D uploads a history of a delivery process. The history of the delivery process includes, for example, information on delivery of the product 700 packed in the corrugated containers 800. The information processing device 40E uploads a history of a store process. The history of the store process includes, for example, information on work at a store where the product 700 is received. The work at the store includes removal of the product 700 from the corrugated container 800, subdividing the product 700, and packaging the product 700, etc. to provide merchandise 900. A two-dimensional code 910 is used for tracking a distribution route and is attached to the merchandise 900. A method of generating the two-dimensional code 910 will be described later.

Further description is now made with reference to FIG. 1.

The server device 10 records a history uploaded from the information processing device 40A as agricultural field ledger data 21; a history uploaded from the information processing device 40B as crop ledger data 22; a history uploaded from the information processing device 40C as sorting ledger data 23; a history uploaded from the information processing device 40D as delivery ledger data 24; and a history uploaded from the information processing device 40E as store ledger data 25.

The purchaser terminal 50 is used by a purchaser of merchandise. The purchaser terminal 50 downloads content according to a history of the product from the server device 10 via the network NW. For example, the purchaser terminal 50 accesses the server device 10 by scanning a two-dimensional code 910 (refer to FIG. 2) attached to merchandise 900 and specifies access destination information decoded from the scanned two-dimensional code 910. The access destination information indicates an access destination, and in the present embodiment is a URL (uniform resource locator). The purchaser terminal 50 downloads the content transmitted by the server device 10 in response to this access.

Although only one purchaser terminal 50 is shown in FIG. 1, in actuality a plurality of purchaser terminals 50 exist. While in FIG. 1 the purchaser terminal 50 is a personal computer, the purchaser terminal 50 may be, for example, a portable terminal such as a smartphone or a tablet computer.

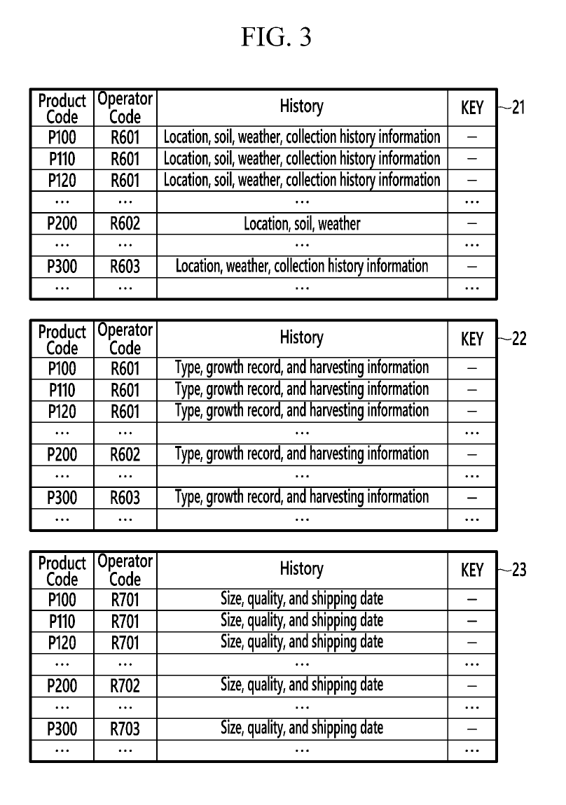

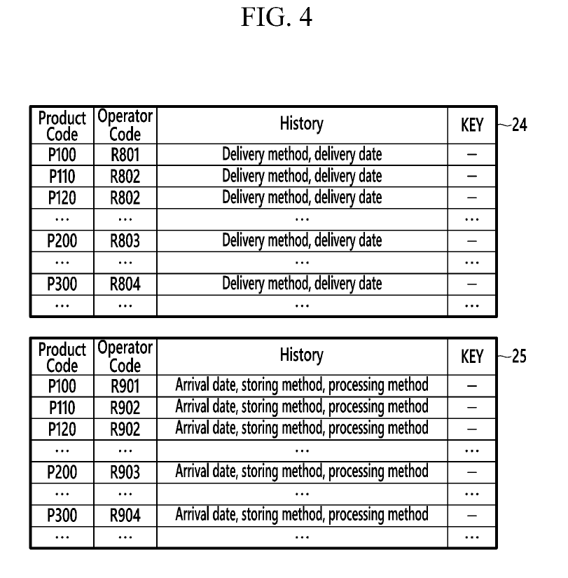

FIG. 3 and FIG. 4 are diagrams showing an example each of a configuration of ledger data recorded in a ledger database 20. In the present embodiment, ledger data is data in a table format.

As shown in FIG. 3, agricultural field ledger data 21 has a structure in which a “product code,” an “operator code,” a “history” of an agricultural field process, and a “key” are associated with each other for each of a plurality of products.

The “product code” is an identifier assigned to the product. The product code is assigned to a predetermined unit of the product. The product code may be assigned to each one of the products (in this embodiment, one for each farm product), to two or more products of the same type, or may be assigned to two or more products produced in the same agricultural field at the same time. The product code may be, for example, an identifier such as a lot number or a serial number. The product code is also recorded in ledger data other than the agricultural field ledger data 21. The “operator code” is an identifier for identifying an operator (for example, a farmer) who has carried out the agricultural field process for the product indicated by the product code. The history of the agricultural field process includes, for example, an agricultural field location, soil, weather, and a history (collection history information) obtained by use of the history collecting device 30.

Types of history recorded in the ledger data may differ depending on the operator or the product. For example, an operator who wishes to provide a detailed history of a product will record a relatively large number of types of history. In the agricultural field ledger data 21 shown in FIG. 3, the types of history associated with the operator code “R601,” the types of history associated with the operator code “R602,” and the types of history associated with the operator code “R603” differ from each other.

The “key” is a character string composed of one or more characters, which is a base for generating access destination information. The key is also recorded in ledger data other than the agricultural field ledger data 21. Details of the key will be described later. In the register data shown in FIG. 3 and FIG. 4, a key has not yet been recorded.

The crop register data 22 has a structure in which a “product code,” an “operator code,” a “history” of a crop process, and a “key” are associated with each other. The operator code is an identifier for identifying an operator (for example, a farmer) who has carried out work on the crop process for the product indicated by the product code. The history of the crop process includes, for example, harvest information indicating a type of product, and a growth record, and harvesting work for the product.

The sorting ledger data 23 has a structure in which a “product code,” an “operator code,” a “history” of a sorting process, and a “key” are associated with each other. The operator code is an identifier for identifying an operator (for example, a classifier) who has performed work for the sorting process for the product indicated by the product code. The history of the sorting process includes, for example, information on a product size, quality, and shipping date.

The delivery ledger data 24 has a structure in which a “product code,” an “operator code,” a “history” of a delivery process, and a “key” are associated with each other. The operator code is an identifier for identifying an operator (for example, a delivery company) who has performed work for the delivery process of the product indicated by the product code. The history of the delivery process includes, for example, a delivery method (for example, a storage method, such as refrigerated storage or storage at ambient temperature, or a transportation method), and a delivery date.

The store ledger data 25 has a structure in which a “product code,” an “operator code,” a “history” of a store process, and a “key” are associated with each other. The operator code is an identifier for identifying an operator (for example, a store) where work relative to the store process for the product indicated by the product code is performed. The history of the store process includes, for example, an arrival date of the merchandise at the store, a method of storing the product, and a method of processing the product (for example, a cooking method).

The types of history stated above as being recorded in the above-described ledger data are merely examples. The history of the product may include information on another type of product or may not include one or more of the above described types of history. Further, for example, an identifier assigned in units of corrugated container 800 described in FIG. 2 or an identifier assigned in units of merchandise 900 may be recorded in the ledger data as the identifier for identifying the product.

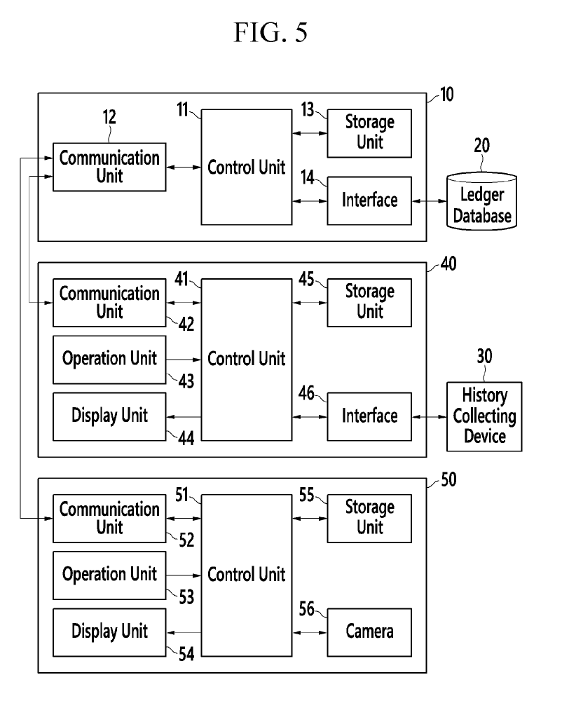

FIG. 5 is a block diagram showing a hardware configuration of a server device 10, an information processing device 40, and a purchaser terminal 50. The server device 10 includes a control unit 11, a communication unit 12, a storage unit 13, and an interface 14.

The control unit 11 is a processor having a CPU (central processing unit), a ROM (read only memory), and a RAM (random access memory) as an arithmetic processing unit. The CPU loads a program stored in the ROM or the storage unit 13 to the RAM and executes the program, thereby controlling each unit of the server device 10. The communication unit 12 includes, for example, a modem and communicates with the information processing device 40 and the purchaser terminal 50 via a network NW. The communication unit 12 transmits and receives data under control of the control unit 11. The storage unit 13, for example, is a hard disk on which a program or the like is stored for executing control of the server device 10. The interface 14 is an interface connected to a ledger database 20.

The information processing device 40 includes a control unit 41, a communication unit 42, an operation unit 43, a display unit 44, a storage unit 45, and an interface 46. For example, the control unit 41, the communication unit 42, and the storage unit 45 may have the same configuration as hardware having the same name as that of the server device 10. The communication unit 42 communicates with the server device 10 via the network NW. The operation unit 43 includes, for example, a keyboard and a mouse for accepting an operation. The display unit 44 is, for example, a liquid crystal display and is capable of displaying various screens. The storage unit 45 stores a program (for example, a browser or a dedicated application program) that uses functions provided by the history management system 1. The interface 46 is an interface for acquiring information collected by a history collecting device 30.

The purchaser terminal 50 includes a control unit 51, a communication unit 52, an operation unit 53, a display unit 54, a storage unit 55, and a camera 56. For example, the control unit 51, the communication unit 52, the operation unit 53, the display unit 54, and the storage unit 55 have the same configuration as hardware having the same name as that of the information processing device 40. The communication unit 52 communicates with the server device 10 via the network NW. The storage unit 55 stores a program (for example, a browser or a dedicated application program) that uses functions provided by the history management system 1. The camera 56 includes, for example, an image pickup device and a lens, and is used to perform imaging.

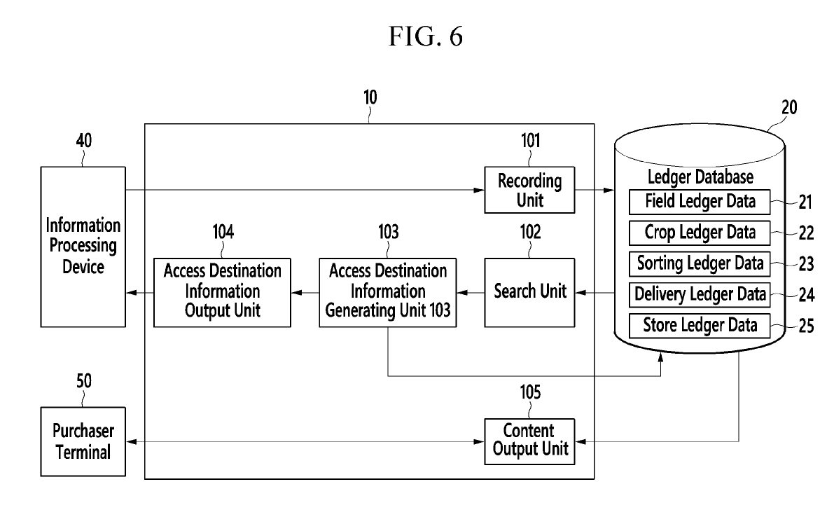

FIG. 6 is a block diagram showing a functional configuration of a history management system 1.

In the history management system 1, a server device 10 has functions corresponding to those of a recording unit 101, a search unit 102, an access destination information generating unit 103, an access destination information output unit 104, and a content output unit 105.

With respect to each of a plurality of products, the recording unit 101 records in a ledger database 20 a history each of a plurality of processes through which a product passes. In detail, the recording unit 101 records the history of the product uploaded from the information processing device 40 to an appropriate ledger data in association with a product code of the product.

The search unit 102 searches for the history of each of a plurality of processes from the ledger database 20 (ledger data), for each product. For example, the search unit 102 searches for the history of a product indicated by the product code by using the product code as a search key.

With respect to a product for which a history each of the plurality of processes has been acquired by the search carried out by the search unit 102, the access destination information generating unit 103 generates unique access destination information for the content history of the plurality of processes. That is, the access destination information is unique not only to the product but also to the content history of the product. On the other hand, the access destination information generating unit 103 does not generate the access destination information for a product for which a history for at least a part of the plurality of processes has not been acquired.

The access destination information output unit 104 outputs the access destination information generated by the access destination information generating unit 103. An output destination of the access destination information is, for example, the information processing device 40E. In this case, the information processing device 40E prints a two-dimensional code to which the access destination information is encoded and outputs the two-dimensional code. A task of attaching the two-dimensional code to merchandise is performed at the store.

When receiving an access request designating access destination information from the purchaser terminal 50, the content output unit 105 outputs content corresponding to a history each of a plurality of processes specified by the access destination information. Here, the content includes information on a distribution route of the product. Similar to the history in the ledger data, the content includes data in the form of text (written description), a still or moving image, but may also include other data.

In the present embodiment, the recording unit 101, the access destination information output unit 104, and the content output unit 105 are realized by cooperation with the control unit 11 and the communication unit 12 of the server device 10. The search unit 102 and the access destination information generating unit 103 are realized by the control unit 11.

Next, an operation of the present embodiment will be described.

<A: Recording History in Ledger Data>

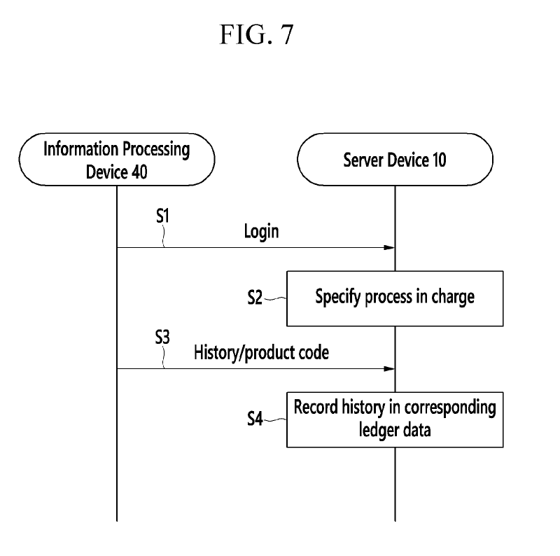

FIG. 7 is a sequence diagram showing processing for recording a history of a product in register data in a history management system 1. An operation for recording a history each in the respective information processing devices 40A to 40E is essentially the same, except that a process performed by an operator and a history content to be recorded are different. Therefore, hereinafter, the operation for recording a history in the ledger is described collectively as the “information processing device 40.”

First, a worker operates an operation unit 43 of the information processing device 40 to perform an operation of inputting an operator code and a password. Then, the information processing device 40 logs in to a server device 10 (step S1). In detail, a control unit 41 transmits the inputted operator code and password to the server device 10 via a communication unit 42. When login of the information processing device 40 is permitted at the server device 10, a recording unit 101 specifies a process performed by the operator based on the operator code (step S2).

Next, the information processing device 40 uploads (transmits) to the server device 10 a history of a product to be recorded in ledger data, together with a product code of the product (step S3). For example, the control unit 41 displays a history input screen on the display unit 44, and accepts input of the product code and the history by use of this screen. Further, the control unit 41 acquires the history of the product from a history collecting device 30 via an interface 46. Then, the control unit 41 transmits the history of the product to be recorded in the ledger data to the server device 10 via the communication unit 42.

The product code may be understood and acquired by an operator of each process by using a document (delivery note or order form) exchanged between operators in the process of product distribution, or a method such as communication between the information processing devices 40.

The recording unit 101 of the server device 10 records the history uploaded from the information processing device 40 in the corresponding ledger data in association with the product code uploaded together therewith, and the operator code used for the login (step S4).

<B: Searching for History>

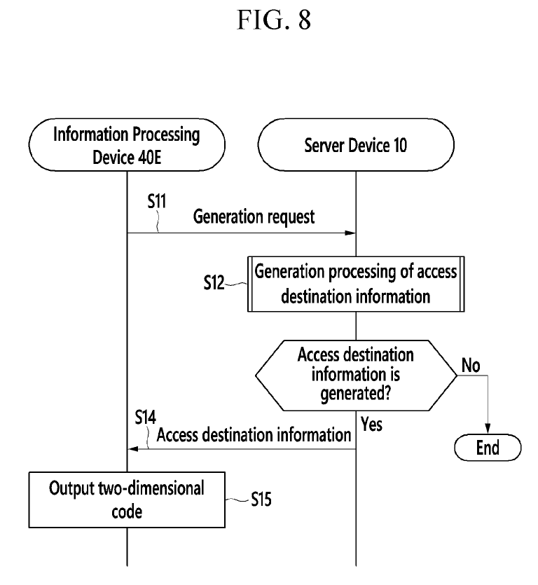

FIG. 8 is a sequence diagram showing processing for searching for a history in a history management system 1. It is assumed that each ledger data is in a state as described with reference to FIG. 3 and FIG. 4 at a start time of the processing described below.

A worker who operates an information processing device 40E performs an operation to request generation of access destination information by using an operation unit 43. In response to this operation, the information processing device 40E transmits a request to generate the access destination information for supply to a server device 10 (step S11). In detail, a control unit 41 includes a product code of a target product for generating the access destination information in the request, and then transmits the request to the server device 10 via the communication unit 42. The product code may be input by the worker who operates the information processing device 40E, or may be set automatically. In the server device 10, a search unit 102 and an access destination information generating unit 103 perform access destination information generating processing based on the received generation request (step S12).

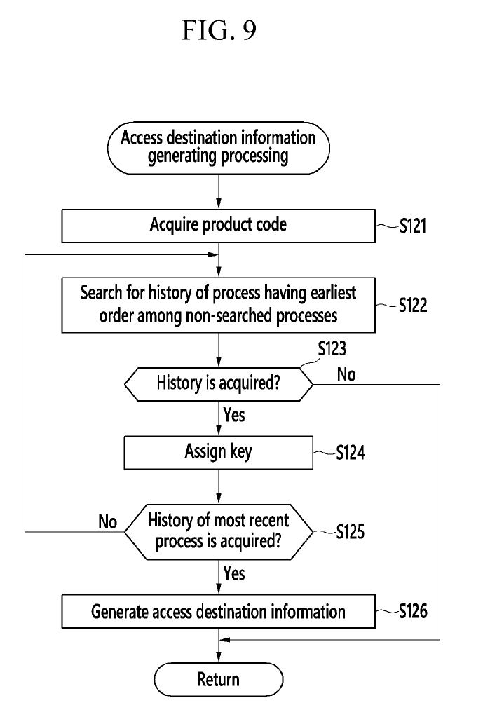

FIG. 9 is a flowchart showing access destination information generating processing.

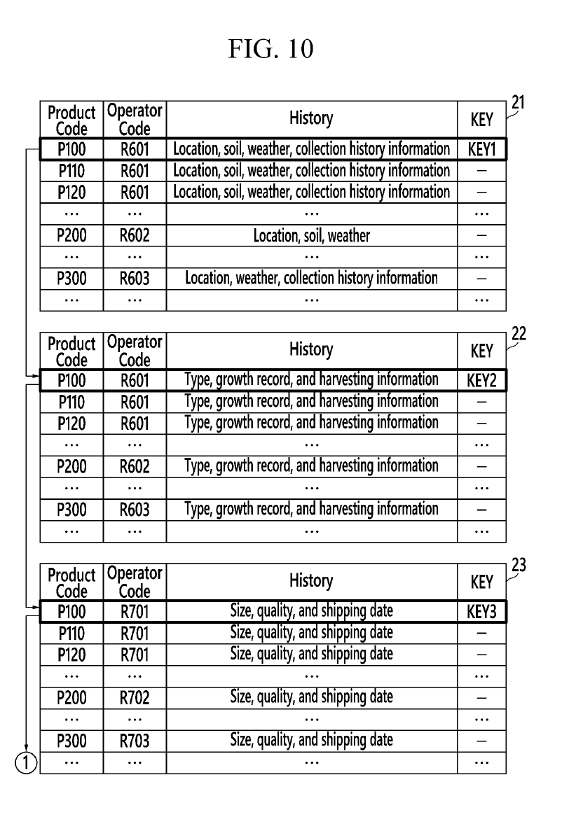

A search unit 102 acquires a product code included in a generation request (step S121). Here, it is assumed that the search unit 102 acquires the product code “P100.” Next, the search unit 102 searches for a history of a process having an earliest order among processes that have not yet been searched for (step S122). Here, the search unit 102 searches for a history associated with the product code “P100” from agricultural field ledger data 21 corresponding to an agricultural field process. Next, the search unit 102 determines whether or not a history is acquired (step S123). Here, since the search unit 102 acquires a history in a record of the first row shown in FIG. 10, “YES” is determined at the step S123.

Next, an access destination information generating unit 103 assigns a key to the acquired history (step S124). The key is assigned so as not to overlap with other keys of the same ledger data. The access destination information generating unit 103 assigns the key by, for example, determining a character string either randomly or in accordance with a predetermined algorithm. Here, it is assumed that “KEY 1” is assigned as the key. As shown in FIG. 10, the access destination information generating unit 103 records the key “KEY 1” in the agricultural field ledger data 21 in association with the product code “P100.”

Next, the search unit 102 determines whether a history of the most recent process has been acquired (step S125). Here, since only the agricultural field process has been searched, the search unit 102 determines “NO” at the step S125 and returns to the step S122.

Next, the search unit 102 searches for a history of a process having the earliest order among processes that have not yet been searched for (step S122). Here, the search unit 102 searches for a history associated with the product code “P100” from crop register data 22 corresponding to a crop process. Next, the search unit 102 determines whether a history is acquired (step S123). Here, since the search unit 102 acquires a history in a record of the first row shown in FIG. 10, “YES” is determined at the step S123. Next, the access destination information generating unit 103 assigns a key to the acquired history (step S124). Here, it is assumed that “KEY 2” is assigned as the key. As shown in FIG. 10, the access destination information generating unit 103 records the key “KEY 2” in the crop register data 22 in association with the product code “P100.” Next, the search unit 102 determines whether the history of the most recent process has been acquired (step S125). In this case, since the search has been performed only up to the crop process, the search unit 102 determines “NO” at the step S125 and returns to the step S122.

Next, the search unit 102 searches for a history of a process having the earliest order among processes that have not yet been searched for (step S122). Here, the search unit 102 searches for a history associated with the product code “P100” from sorting register data 23 corresponding to a sorting process. Next, the search unit 102 determines whether a history is acquired (step S123). Here, since the search unit 102 acquires a history in a record of the first row shown in FIG. 10, “YES” is determined at the step S123. Next, the access destination information generating unit 103 assigns a key to the acquired history (step S124). Here, it is assumed that “KEY 3” is assigned as the key. As shown in FIG. 10, the access destination information generating unit 103 records the key “KEY 3” in the sorting register data 23 in association with the product code “P100.” Next, the search unit 102 determines whether the history of the most recent process has been acquired (step S125). In this case, since the search has been performed only up to the sorting process, the search unit 102 determines “NO” at the step S125 and returns to the step S122.

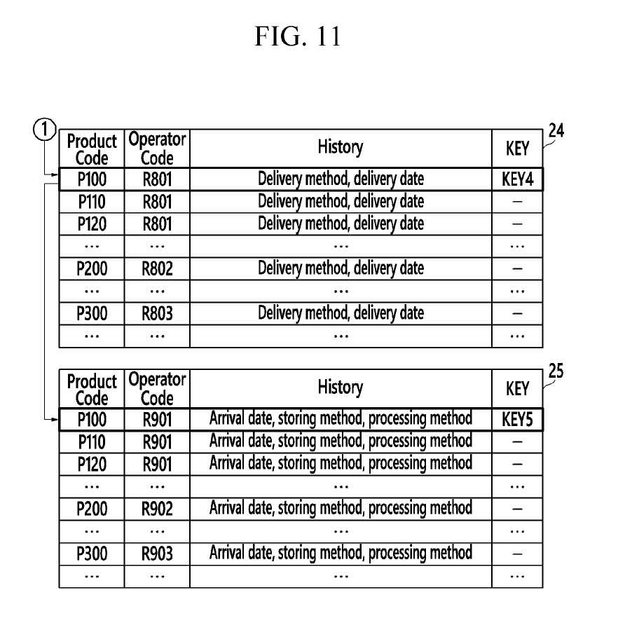

Next, the search unit 102 searches for a history of a process having the earliest order among processes that have not yet been searched for (step S122). Here, the search unit 102 searches for a history associated with the product code “P100” from delivery ledger data 24 corresponding to a delivery process. Next, the search unit 102 determines whether a history is acquired (step S123). Here, since the search unit 102 acquires a history in a record of the first row shown in FIG. 11, “YES” is determined at the step S123. Then, the access destination information generating unit 103 assigns a key to the acquired history (step S124). Here, it is assumed that “KEY 4” is assigned as the key. As shown in FIG. 11, the access destination information generating unit 103 records the key “KEY 4” in the delivery ledger data 24 in association with the product code “P100.” Next, the search unit 102 determines whether the history of the most recent process has been acquired (step S125). In this case, since the search process has been performed only up to the delivery process, the search unit 102 determines “NO” at the step S125 and returns to the step S122.

Next, the search unit 102 searches for a history of a process having the earliest order among processes that have not yet been searched for (step S122). Here, the search unit 102 searches for a history associated with the product code “P100” from store ledger data 25 corresponding to a store process. Next, the search unit 102 determines whether a history is acquired (step S123). Here, since the search unit 102 acquires a history in a record of the first row shown in FIG. 11, “YES” is determined at the step S123. Then, the access destination information generating unit 103 assigns a key to the acquired history (step S124). Here, it is assumed that “KEY5” is assigned as the key. As shown in FIG. 11, the access destination information generating unit 103 records the key “KEY5” in the store ledger data 25 in association with the product code “P100.” Next, the search unit 102 determines whether the history of the most recent process has been acquired (step S125). Here, since the search has been performed up to the store process with the most recent order, the search unit 102 determines “YES” in the step S125.

Next, the access destination information generating unit 103 generates access destination information (step S126). This access destination information does not overlap with any other access destination information generated based on a history of another product or another content of the same product.

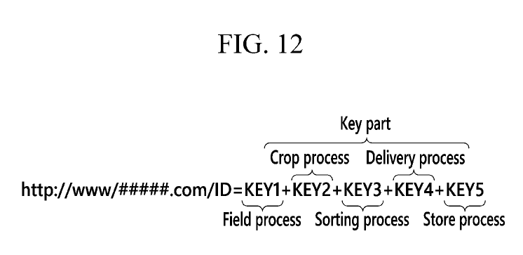

In detail, the access destination information generating unit 103 generates the access destination information by combining the keys assigned to a history each of the respective processes in the step S124. Here, for the product having product code “P100,” the key “KEY 1” is assigned to the history of the agricultural field process, the key “KEY 2” is assigned to the history of the crop process, the key “KEY 3” is assigned to the history of the sorting process, the key “KEY 4” is assigned to the history of the sorting process, and the key “KEY 5” is assigned to the history of the storage process. In this case, the access destination information generating unit 103 stores the access destination information of “http://www.#####.com/ID=KEY1+KEY2+KEY3+KEY4+KEY5” as shown in FIG. 12. The portion of “http://www.#####.com/” in the access destination information is information indicating access to the server device 10, and is common information that is not dependent on the contents of the product and its history. For convenience of explanation, he portion of “ID=KEY1+KEY2+KEY3+KEY4+KEY5” in the access destination information is hereinafter referred to as a “key part,” This key part is used to specify a distribution route of the product; that is, a history each of the plurality of processes. Here, the key part is configured by combining the keys of the respective processes using the symbol “+”.

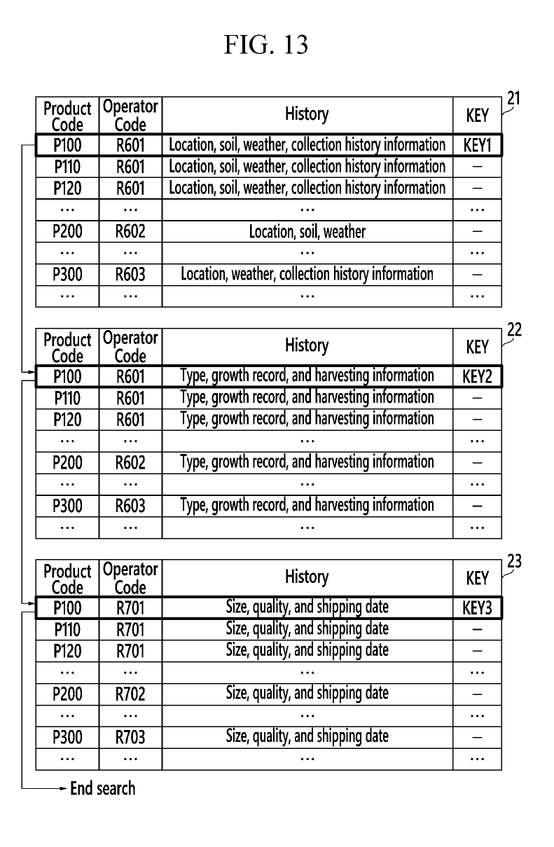

On the other hand, if it is determined in step S123 that a history of a process cannot be obtained (step S123: NO), the search unit 102 does not search for a history of a subsequent process and ends the search (the access destination information generating processing). As shown in FIG. 13, when no history can be acquired from the sorting ledger data 23 corresponding to the sorting process (a first process), the search unit 102 does not perform a search for the ledger data of the delivery process and the store process (a second process) which take place later than the sorting process. Accordingly, access destination information is not generated for a product for which a distribution route, that is, a history each of a plurality of processes has not yet been completed.

In the step S123, when the product code included in the generation request is not recorded in the ledger data, or when there are two or more of a history each for the same process relating to the same product, “NO” may be determined, and the access destination information generating processing may end.

In the foregoing, description has been given for access destination information generating processing.

Further description will now be given with reference to FIG. 8.

Upon completion of the access destination information generating processing, the access destination information output unit 104 determines whether the access destination information has been generated (step S13). If “YES” is determined in the step S13, the access destination information output unit 104 transmits the access destination information to the information processing device 40E, which is a transmission source of the generation request (step S14). The access destination information may be transmitted as data in the form of a character string, or may be transmitted after being converted into a two-dimensional code. A format of the data is not limited.

When “NO” is determined in the step S13, the access destination information output unit 104 does not output the access destination information.

Upon receiving the access destination information, the information processing device 40E prints the two-dimensional code in which the access destination information is encoded and outputs the two-dimensional code (step S15). In detail, the control unit 41 outputs the two-dimensional code by printing it with a printing device (not shown) connected to the information processing device 40E. When the two-dimensional code is printed, a worker at the store attaches the two-dimensional code to the merchandise. The merchandise to which the two-dimensional code is attached is sold at the store. For example, when the product code “P100” indicates the product 700 described in FIG. 2, the two-dimensional code 910 is attached to the merchandise 900.

While generation of the access destination information of the product with the product code “P100” has been described above, access destination information may also be generated for products with other product codes by use of the above-described procedure.

<C: Downloading Content>

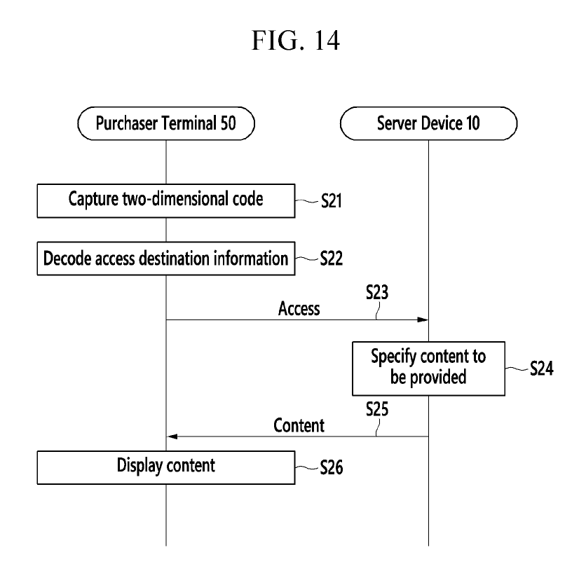

FIG. 14 is a sequence diagram showing processing for downloading content in a history management system 1.

When a purchaser who purchases merchandise wishes to obtain information on a distribution route of the merchandise, the purchaser may use a camera 56 of a purchaser terminal 50 to capture a two-dimensional code attached to the merchandise (step S21). Then, a control unit 51 of the purchaser terminal 50 decodes access destination information from the two-dimensional code (step S22), and then accesses a server device 10 by specifying the access destination information (step S23). It is assumed that the two-dimensional code 910 is captured by the camera 56. In this case, the control unit 51 designates “http://www.#####.com/ID=KEY1+KEY2+KEY3+KEY4+KEY5” as the access destination information, and accesses the server device 10 via a communication unit 52.

A content output unit 105 of the server device 10, upon receiving the access from the purchaser terminal 50, specifies a content to be provided based on a content history for each of a plurality of processes specified by the access destination information (step S24).

In the step S24, the content output unit 105 specifies content corresponding to a key part included in the access destination information. When the access destination information is “http://www.#####.com/ID=KEY1+KEY2+KEY3+KEY4+KEY5,” the content output unit 105 extracts a history associated with a key “KEY 1” from agricultural field register data 21, a history associated with the key “KEY 2” from crop register data 22, a history associated with a key “KEY 3” from sorting register data 23, a history associated with a key “KEY 4 from delivery ledger data 24, and a history associated with a key “KEY5” from store ledger data 25. Then, the content output unit 105 specifies content including contents of the extracted history each of the plurality of processes as the content to be provided.

Next, the content output unit 105 outputs (transmits) the specified content to the purchaser terminal 50 (step S25). The purchaser terminal 50 displays the downloaded content (step S26). In detail, the control unit 51 displays the content that is received via the communication unit 52 using a display unit 54.

<D: Rewriting History>

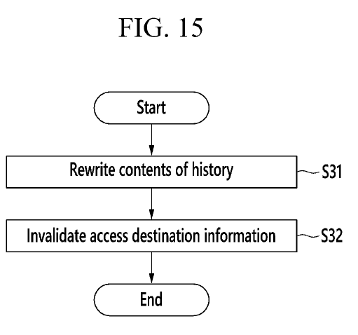

FIG. 15 is a flowchart showing a process of rewriting a history executed by a server device 10. For example, an operator may change a content of a history that has been recorded in ledger data by rewriting it. In this case, the server device 10 executes processing as described below.

In the server device 10, a recording unit 101 rewrites the history content recorded in the ledger data in response to a request from an information processing device 40 (step S31). Rewriting the content history may be performed, for example, in the same order as the procedure described in FIG. 8. Thus, rewriting is performed when the operator adds new contents of the history or corrects the contents in good faith. However, this rewriting is not necessarily carried out in good faith, and there is a possibility of falsification with malicious intent.

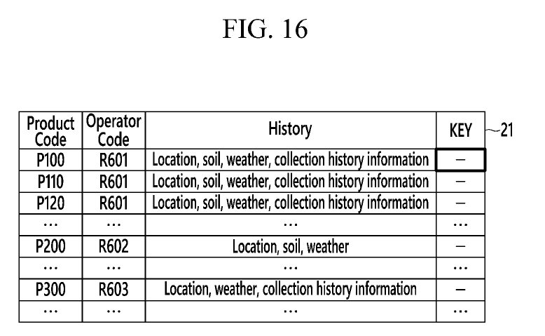

Therefore, when the contents of the history are rewritten, an access destination information generating unit 103 of the server device 10 invalidates access destination information generated based on the contents of the history prior to the rewriting (step S32). Here, the process of the step S32 is a process of invalidating a key associated with the rewritten history. The process of invalidating the key is performed, for example, by deleting the key or by replacing the key with another character string. For example, if the contents of the history of the product code “P100” in agricultural field ledger data 21 are rewritten, the agricultural field ledger data 21 is as shown in FIG. 16.

Due to the invalidation of the access destination information, information corresponding to the content history of the rewritten history is not provided to a purchaser terminal 50 based on a two-dimensional code generated prior to rewriting of the content history. As a result, information on an erroneous distribution route based on the content history after tampering is not provided to a purchaser of the merchandise.

When the content history is rewritten in good faith, access destination information (a two-dimensional code) is generated after the rewriting such that an operation of attaching the two-dimensional code to the merchandise can be performed. As a result, inconvenience in providing content history information does not arise.

In the history management system 1 described above, when a history each of a plurality of processes through which a product passes is completed, unique access destination information is generated for the product together with a content history each of the plurality of processes for the product. On the other hand, in the history management system 1, when the history each of the plurality of processes is not complete, no access destination information is generated. Therefore, with respect to a product for which a history each of one or more processes is unknown, the content (information on the distribution route) history of the product is not provided to the purchaser terminal 50.

A key included in the access destination information is a character string unique to the content history of each process relating to each product. Each time the access destination information generating processing is executed, this key is assigned to the history. Therefore, even if the content history of the ledger data is tampered with after the two-dimensional code is attached to the merchandise with respect to a certain product, the content history after tampering has taken place is not provided. Thus, according to the history management system 1, it is possible to secure a reliable history for each of the plurality of processes through which the product passes and to provide a corresponding content history.

### MODIFIED EXAMPLES

The above-described embodiment is one embodiment of the present invention and may be variously modified. Modified examples of the above-described embodiment are described below. The following modified examples may be combined appropriately.

### Modified Example 1

When access destination information is generated, a content output unit 105 of a server device 10 may output (store) content to a storage location specified by the access destination information. That is, the content may be managed separately from a history recorded in ledger data. In this case, a purchaser terminal 50 uses the access destination information decoded from a two-dimensional code to download the content from the storage location specified by a key part of the access destination information

In this modified example, the content is managed separately from the ledger data. Therefore, even if the content history of the ledger data is tampered with after merchandise is sold, a purchaser terminal 50 can download the content corresponding to the content history prior to the tampering.

### Modified Example 2

An access destination information generating unit 103 may assign to a key a character string obtained by converting content of a history recorded in each register data according to a predetermined rule. For example, when the content history is in the form of a character string (text), the character string is converted into another character string according to a predetermined rule. Furthermore, when outputting content, a content output unit 105 converts the content history recorded in each ledger data into a character string according to the same rule. Then, the content output unit 105 determines whether the character string obtained by the conversion matches (exactly match) the key included in the access destination information. The content output unit 105 outputs the content when they exactly match, and does not output the content when they do not exactly match.

As such, the server device 10 can confirm that there is no possibility that the content history has been tampered with at the time of outputting the content. Such a configuration is preferable because content is not provided based on the content history after tampering has taken place.

### Modified Example 3

In access destination information generating processing, a server device 10 may search for a history by referring to ledger data in a reverse order to which the processes took place rather than the actual order. Further, the server device 10 may search for a history by referring to each ledger data regardless of an order of the processes. In this case, unless the history each of all of the plurality of processes is completed, access destination information is not generated, whereby content corresponding to content of history that has been tampered with is not provided to a purchaser terminal 50.

### Modified Example 4

In the above-described embodiment, a key is assigned at a timing when a history is retrieved from ledger data. The timing of assignment of this key is merely an example, and the key may be assigned, for example, at a timing when the history is recorded (including a case where the history is rewritten).

### Modified Example 5

An identifier assigned to a certain product may be different for each set of ledger data (each process). For example, when work described with reference to FIG. 2 is performed, a product code of a product 700 may be recorded in agricultural field register data 21 and crop register data 22; an identifier in units of corrugated container 800 may be recorded in sorting ledger data 23 and delivery ledger data 24; and an identifier in units of merchandise 900 may be recorded in store ledger data 25. In such a case, if a correspondence between a product code of the product 700, the identifier of the corrugated container 800 in which the product 700 is packed, and the identifier of the merchandise 900 including the product 700, which is subdivided from the corrugated container 800 is known, a distribution route of each product can be traced. As a result of such configuration, for example, in a case where raw materials consist of a plurality of vegetables and a final product (merchandise) is a product cooked using the plurality of vegetables, a purchaser can acquire information on the distribution route of each of the raw materials.

Further, the identifier used for searching the history need not be the product code. For example, the history may be searched by using an operator code that identifies an operator, such as a producer of a product, who performs the work of each process.

### Modified Example 6

The product, the types of processes, the number of processes, and the types of history described in the above embodiment are merely examples. For example, one information processing device 40 may upload a history of two or more processes to a server device 10. Further, the server device 10 may transmit access destination information generated in access destination information generating processing to an information processing device 40 other than an information processing device 40E.

The method of generating access destination information described in the above embodiment represents only one example. That is, access destination information in a format different from that described with reference to FIG. 12 may be generated. The access destination information may, for example, not include a combination of keys assigned to each of a history. Furthermore, the access destination information may be information indicating an access destination other than a URL.

The access destination information may be information that is unique to a history of each process of a plurality of processes through which a product passes as well as being unique to the product. By use of such access information, the same effect as that obtained in the above-described embodiment can be achieved with respect to providing content a reliability of which is assured.

Ledger data need not be separated for each of a plurality of processes. That is, a history each of two or more processes may be recorded in one ledger data. In addition, one server device 10 need not manage a history each of the plurality of processes, but rather each of a plurality of server devices may manage a history of one particular process. Further, a separate ledger database may be used for each of a plurality of processes.

An encoded image obtained by encoding access destination information is not limited to a two-dimensional code, and may be an image such as a bar code. Further, a character string indicating the access destination information may be attached to the merchandise without using the encoded image.

Among the functions described in the above embodiment, a part of the functions of the server device 10 in the above-described embodiment may be included in a device other than the server device 10, such as an information processing device 40. That is, in the history management system of the present invention, there is no limitation on an entity that may be used to realize each function. Further, the order of the processes executed in the respective devices of the history management system 1 may be appropriately switched. Furthermore, some of the configurations and operations described in the above embodiments may be omitted.

### Modified Example 7

Each function realized by the history management system 1 according to the above-described embodiment may be realized by one or more hardware circuits, or by executing one or more programs, or by use of a combination thereof. In a case where the function of the history management system 1 is realized by using a program, the program may be recorded on a magnetic recording medium (a magnetic tape, a magnetic disk (a hard disk drive (HDD), a flexible disk (FD), etc.)), an optical recording medium (optical disk, etc.), a magneto-optical recording medium, a semiconductor memory, or the like, or may be distributed via a network. Furthermore, the present invention may be realized as a history management method of a product.

The present invention is not limited to the above-described embodiments, and it is understood that various modifications are possible within the scope of the appended claims, and therefore within the scope of the present invention.

1. A history management system including:
a recording unit that records in a database, relative to a plurality of products, a history each of a plurality of processes through which the plurality of products passes;
a search unit that searches the database for the history each of the plurality of processes through which the plurality of products passes;
an access destination information generating unit that generates access destination information unique to the history each of the plurality of processes through which the plurality of products passes and for which the history each has been acquired by the search;
an access destination information output unit that outputs the generated access destination information; and
a content output unit that outputs a content history corresponding to the history each of the plurality of processes specified by the access destination information when receiving an access request designating the access destination information.

2. The history management system according to claim 1, wherein when the content history is rewritten, the access destination information generating unit invalidates the access destination information generated based on the content history before rewriting.

3. The history management system according to claim 1, wherein the access destination information generating unit generates the access destination information by assigning character strings to the history acquired by the search, and combining the character strings, with respect to each of the plurality of processes.

4. The history management system according to claim 3, wherein the access destination information generating unit assigns the character strings by converting the history content according to a predetermined rule, and
wherein the content output unit outputs the content when the character strings acquired by converting the history content according to the predetermined rule are included in the access destination information.

5. The history management system according to claim 1, wherein the database stores ledger data provided for each of the plurality of processes, with a history each of the plurality of processes being recorded in the ledger data, and
wherein the search unit, when a history is not acquired from the ledger data corresponding to a first process, does not search for the history for the ledger data corresponding to a second process an order of which is subsequent to an order of the first process.

6. The history management system according to claim 1, wherein the recording unit causes a type of history for recordal to differ depending on the product or a worker performing work on the product.

7. The history management system according to claim 1, further comprising a collecting device that collects information on a history of the product,
wherein the recording unit records the history based on the information collected by the collecting device.

8. The history management system according to claim 1, wherein the product is a farm product, and
wherein the history includes information on an agricultural field in which the farm product is produced.

9. A history management method comprising:
recording in a database relative to a plurality of products, a history each of a plurality of processes through which the plurality of products passes;
searching the database for the history each of the plurality of processes through which the plurality of products passes;
generating access destination information unique to the history each of the plurality of processes through which the plurality of products passes and for which the history each has been acquired by the search;
outputting the generated access destination information; and
outputting a content history corresponding to the history each of the plurality of processes specified by the access destination information when receiving an access request designating the access destination information.
